(19) United States
(12) Patent Application Publication
(10) Pub. No.: US 2009/0183371 A1
(43) Pub. Date: Jul. 23, 2009

(54) Razor With Integrated Dispensing of Shaving Treatments

(76) Inventors: Robert J. Mileti, Torrington, CT (US); Roger J. Laflamme, Enfield, CT (US)

Correspondence Address: ST. ONGE STEWARD JOHNSTON & REENS, LLC, 986 BEDFORD STREET, STAMFORD, CT, 06905-5619, US

(21) Appl. No.: 12/358,942

(22) Filed: Jan. 23, 2009

Related U.S. Application Data
(60) Provisional application No. 61/022,999, filed on Jan. 23, 2008.

(51) Int. Cl. B26B 21/40

(52) U.S. Cl. 30/41.5

(57) ABSTRACT

A shaving apparatus includes a main body, a shaving head attached to the main body and an integrated mechanism for dispensing the shaving treatment disposed within the main body. The integrated mechanism includes a pouch defining a reservoir containing the shaving treatment, at least a portion of the pouch being flexible such that the reservoir decreases in size as the shaving treatment is withdrawn therefrom, a flexible button at least partially defining a metering chamber in fluid communication with the reservoir, an output one-way valve in fluid communication with the metering chamber and permitting unidirectional flow of the shaving treatment from the metering chamber when the flexible button is pressed by the user and an intake one-way valve disposed between the metering chamber and the reservoir and permitting unidirectional flow of shaving treatment from the reservoir into the metering chamber when the flexible button is released by the user.

### CROSS-REFERENCE TO RELATED APPLICATIONS

This patent application claims the benefit of, under Title 35, United States Code, Section 119(e), U.S. Provisional Patent Application No. 61/022,999, filed Jan. 23, 2008.

### FIELD OF THE INVENTION

The present invention relates generally to shaving apparatus, and more specifically, to razors that include an integrated mechanism for the dispensing of shaving treatments.

### BACKGROUND OF THE INVENTION

In the field of shaving and more specifically blade razors, it has long been recognized that the use of soaps, lotions, foams, gels or even water or other liquid or semi-liquid additions can assist in both the hair removal process and also in the protection of the skin. These liquids, gels, foams, soaps and lotions (hereinafter referred to as “shaving treatments”) often serve to enhance gliding of the razor, and in general reduce the abrasions and potential damage to the skin. In addition, optionally “aftershave” scents or colognes are applied within or separate from these other products.

These shaving treatments are sold in many types of containers and forms. While traditionally, some shaving soaps or creams were sold in solid form and required the addition of water to create lather with a brush, more recently most of these products are dispensed in squeeze tubes, squeeze bottles, pump bottles or pressurized cans. In any event, the consumer purchases a separate shaving treatment in a container and applies such to the area to be shaved prior to or during shaving. The application method for these shaving treatments is fairly inconvenient, and most always requires the consumer to apply the substance to his/her hand first, and then to rub the hand with the shaving treatment on the desired area of the skin. The technique requires the shifting back and forth between shaving and the application method, and as such is inconvenient for the consumer.

For the most part, much of the enhancement of these shaving products has focused on the improvement of the lotions, gels and foams themselves, but there has been acknowledgement in the prior art of the inconvenience of current dispensing methods for these products, and the need for improvement. U.S. Pat. No. 7,101,106 to Wiley describes an application device for these “bodytreating” fluids wherein a rotary dispenser applies the fluid material to the surface of the skin. Wiley's device also includes an extended handle to help improve distribution of the fluids and reach parts of the body that may be difficult to reach.

The '106 Wiley patent does attempt to address a shortcoming of the application of shaving additives by making a specialized rotary applicator with handle. This applicator is designed to replace the need for the application of these creams, gels and foams to the hand, and then subsequently applying them by hand. While Wiley's invention would eliminate the need to apply these shaving treatments by hand, it still remains inconvenient in having to shift back and forth between the razor and this other application device. The present invention addresses this need in a much more convenient manner. Rather than create a separate device with a handle and dispensing mechanism, the present invention allows the razor itself to be the application device, and provides for a secure and constant method of dosing shaving treatments. The razor already has its own handle that has been designed for comfort and for reaching appropriate body areas. The present invention takes advantage of the configuration of the razor itself as the application device for the shaving treatments.

While previous attempts have been made to develop such devices, where the razor itself is used as the application device for the shaving treatments, these attempts have suffered from shortcomings of their own.

U.S. Pat. Nos. 6,925,716, 6,964,097, 7,043,841 and 7,137,203 and U.S. Patent Application Publication Nos. 2004/0177510, 2005/0144785 and 2007/0017098 each disclose a shaving apparatus with a shaving aid material pump mechanism. However, even a cursory review of these references reveals that the designs of the shaving apparatus and of the pump mechanisms are relatively complex, rendering them expensive to produce and prone to failure during use. A simplified, less expensive and more reliable design is desirable in many circumstances.

U.S. Patent Application Publication No. 2006/0150386 discloses a razor having a mechanism incorporated therein for dispensing a shaving aid, which dispensing mechanism relies on a user squeezing a bladder holding the shaving aid in order for the shaving aid to be dispensed. While relatively simple in design, this mechanism provides no way for the user to control the amount of shaving aid being dispensed. The harder and the longer the user presses, the more shaving aid is dispensed, rendering it very easy for an excess amount to be expelled. It would be far more desirable for some sort of pumping mechanism to be employed, such that the amount of material being dispensed could be metered.

### SUMMARY OF THE INVENTION

Accordingly, it is an object of the present invention to provide a shaving apparatus which includes an integrated application mechanism for a shaving treatment.

Another object of the present invention is to provide a shaving apparatus having the above characteristics and which has a simplified design as compared to known devices, so as to be less expensive to produce and less prone to failure.

A further object of the present invention is to provide a shaving apparatus having the above characteristics and which allows for the amount of shaving treatment being dispensed to be metered.

These and other objects of the present invention are achieved in accordance with one exemplary embodiment of the present invention by provision of a shaving apparatus with integrated dispensing of a shaving treatment having a main body, a shaving head attached to the main body and an integrated mechanism for the dispensing of the shaving treatment disposed within the main body. The integrated mechanism for the dispensing of the shaving treatment includes a pouch defining a reservoir containing the shaving treatment, at least a portion of the pouch being flexible such that the reservoir decreases in size as the shaving treatment is withdrawn therefrom, a flexible button accessible by a user of the shaving apparatus, the flexible button at least partially defining a metering chamber in fluid communication with the reservoir, an output one-way valve in fluid communication with the metering chamber and permitting unidirectional flow of the shaving treatment from the metering chamber when the flexible button is pressed by the user and an intake one-way valve disposed between the metering chamber and the reservoir and permitting unidirectional flow of shaving treatment from the reservoir into the metering chamber thereby filling the metering chamber when the flexible button is released by the user.

In some embodiments, the output one-way valve comprises a check valve. In certain of these embodiments, the output one-way valve comprises a flap valve. In certain of these embodiments, a flap of the flap valve is integrally formed as part of the flexible button. In some embodiments, the intake one-way valve comprises a check valve. In certain of these embodiments, the intake one-way valve comprises a flap valve. In certain of these embodiments, a flap of the flap valve is integrally formed as part of the flexible button.

In some embodiments, the pouch comprises a rigid or semi-rigid portion and a flexible portion. In certain of these embodiments, the metering chamber is at least partially defined by the flexible button and at least partially defined by the pouch. In some embodiments, the shaving apparatus further includes a conduit fluidly connecting the output one-way valve and the shaving head. In some embodiments, the main body has a hole passing therethrough and the flexible button is accessible through the hole. In some embodiments, the flexible button is transparent or translucent. In some embodiments, the integrated mechanism for the dispensing of the shaving treatment is replaceable and the shaving head and the main body are reuseable.

In accordance with another exemplary embodiment of the present invention, a shaving apparatus with integrated dispensing of a shaving treatment includes a main body having a hole passing therethrough, a shaving head attached to the main body and an integrated mechanism for the dispensing of the shaving treatment disposed within the main body. The integrated mechanism for the dispensing of the shaving treatment includes a pouch defining a reservoir containing the shaving treatment, the pouch comprising a rigid or semi-rigid portion and a flexible portion such that the reservoir decreases in size as the shaving treatment is withdrawn therefrom, a flexible button accessible by a user of the shaving apparatus through the hole passing through the main body, the flexible button and the rigid or semi-rigid portion of the pouch at least partially defining a metering chamber in fluid communication with the reservoir, an output one-way valve in fluid communication with the metering chamber and permitting unidirectional flow of the shaving treatment from the metering chamber when the flexible button is pressed by the user and an intake one-way valve disposed between the metering chamber and the reservoir and permitting unidirectional flow of shaving treatment from the reservoir into the metering chamber thereby filling the metering chamber when the flexible button is released by the user. At least one of the output one-way valve and the intake one-way valve comprises a flap valve that comprises a flap integrally formed as part of the flexible button.

In some embodiments, both of the output one-way valve and the intake one-way valve comprise flap valves, each of which comprises a flap integrally formed as part of the flexible button. In some embodiments, the shaving apparatus further includes a conduit fluidly connecting the output one-way valve and the shaving head. In some embodiments, the flexible button is transparent or translucent. In some embodiments, the integrated mechanism for the dispensing of the shaving treatment is replaceable and the shaving head and the main body are reuseable.

The invention and its particular features and advantages will become more apparent from the following detailed description considered with reference to the accompanying drawings.

### BRIEF DESCRIPTION OF THE DRAWINGS

FIG. 1 is an isometric view of a shaving apparatus with an integrated mechanism for the dispensing of shaving treatments in accordance with an embodiment of the present invention;

FIG. 2 is an exploded view of the shaving apparatus of FIG. 1;

FIG. 3 is an exploded view of the integrated mechanism for the dispensing of shaving treatments of the shaving apparatus of FIG. 1; and

FIG. 4 is partially cut-away view of a portion of the integrated mechanism for the dispensing of shaving treatments of the shaving apparatus taken along line A-A of FIG. 2.

### DETAILED DESCRIPTION OF AN EMBODIMENT OF THE INVENTION

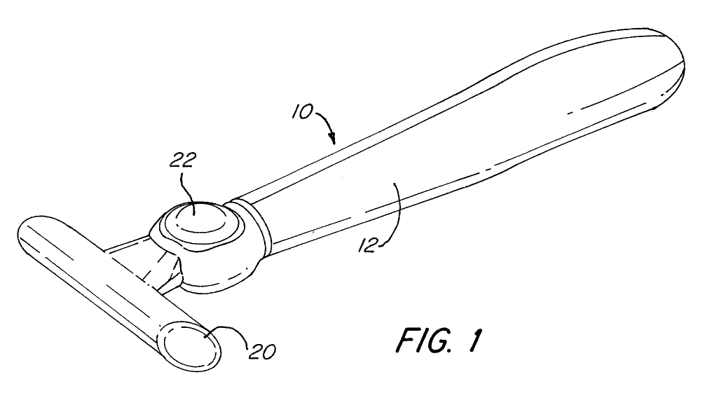

As seen in the attached FIGS. 1-4, the shaving treatment dispensing razor 10 of the present invention includes a main body 12 that contains a bladder or pouch 14 or other storage chamber therein that contains a volume of shaving treatment. A pumping mechanism 16 controls the flow of the shaving treatment from the pouch 14 through a conduit 18 which exits at a directed point near the shaving head 20. It is envisioned that each press of the button 22 of the pumping mechanism 16 dispenses a specific predetermined amount of shaving treatment to a location on the skin or on or near the blades for use by the user. Thus, a metered dose of shaving treatment can be delivered through the conduit 18 as desired by the user. The vacuum pumping method of the present invention (described in more detail below) assures that the shaving treatment is delivered consistently regardless of orientation and/or how much pressure is applied by the user and for how long, and the pumping mechanism 16 is not affected by gravity. This pumping method also assures the relatively complete evacuation of the contents of the pouch 14, which is important as each pouch 14 will by nature of its size contain a fairly small volume of shaving treatment. Any pumping method that would not be able to substantially evacuate the pouch 14 would as such be quite wasteful on a percentage basis.

It is envisioned that in some applications the pouch 14 containing the shaving treatment may be a replaceable self-contained module made at least partially from flexible packaging materials. In other applications, the razor 10 may be designed to be disposable, and in such applications the use of a non-replaceable pouch 14 may be used. A pouch 14 may be sealed, welded or molded from standard Olefin based films or any other flexible sheet material suitable for packing liquids or gels. In some embodiments (discussed in more detail below), only a flexible portion of the pouch 14 is formed of such materials, with a rigid or semi-rigid portion of the pouch 14 being formed from some other material, preferably a polymeric material, by one or more of a variety of processes, such as molding, vacuum forming or any of numerous other fabrication methods. The pumping mechanism 16 device can be integrated within or on the body of the pouch 14 itself. The pumping mechanism 16 may thus be positioned at any point on the main body 12 where it can be easily activated by the user, but the flow of shaving treatment can then be directed through an exit conduit 18 so that it may be applied to the user's skin or the blades (or any other location) where desired. The fact that the pumping mechanism 16 is integrated into or onto the pouch 14 is in many cases critical in allowing the dispensing pouch 14 to fit within and work within the small framework of a razor 10, and to allow the position of the dosing button 22 to be convenient for the user. The exit conduit 18 allows the flow of shaving treatment to be directed where needed, independent of the most convenient location for the pump dosing button 22 itself.

It is also possible, although certainly not necessary, that the pumping mechanism can dose and deliver a given volume of shaving treatment material in adjustable increments. For example, a single press of the dosing button delivers this custom amount of material. In that connection, it is possible that the pumping mechanism can be modified so that the amount of material delivered by each pump of the dosing button can be custom selected by the user. For example, the pump mechanism can be adjustable by use of a dial or other structure to adjustably limited the throw of the dosing button. In other words, an adjustable structure, such as a twistable dial and stop configuration, can be used to control how far the dosing button of the pump can actuate downwardly, thereby limiting and controlling the amount of material delivered in a given press of the dosing button. Thus, the user can custom control the flow of material to the razor. The foregoing structure is one of many different structures and configurations that can be employed to provide adjustable volume delivery of the treatment material in accordance with the present invention.

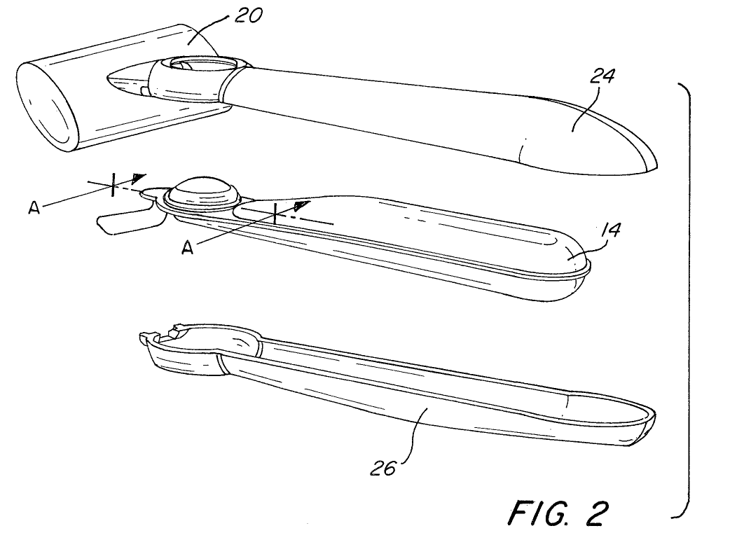

There are a number of methods for affixing the pouch 14 within or to the main body 12 of the razor 10. FIGS. 1 and 2 show one embodiment of integration of the metered dosing pouch 14 within a fairly typical handle razor with blade. In FIG. 2 the pouch 14 is secured within a clam-shell opening in the main body 12, which is formed of an upper handle portion 24 and a lower handle portion 26. The metered dispensing button 22 protrudes through an opening in the upper handle portion 24 so that it may easily be activated by the user. A shaving treatment can be dispensed while shaving by pressing the dosing button 22. The shaving treatment can be directed by means of the exit conduit 18 so that the shaving treatment is applied to the skin near to the blades.

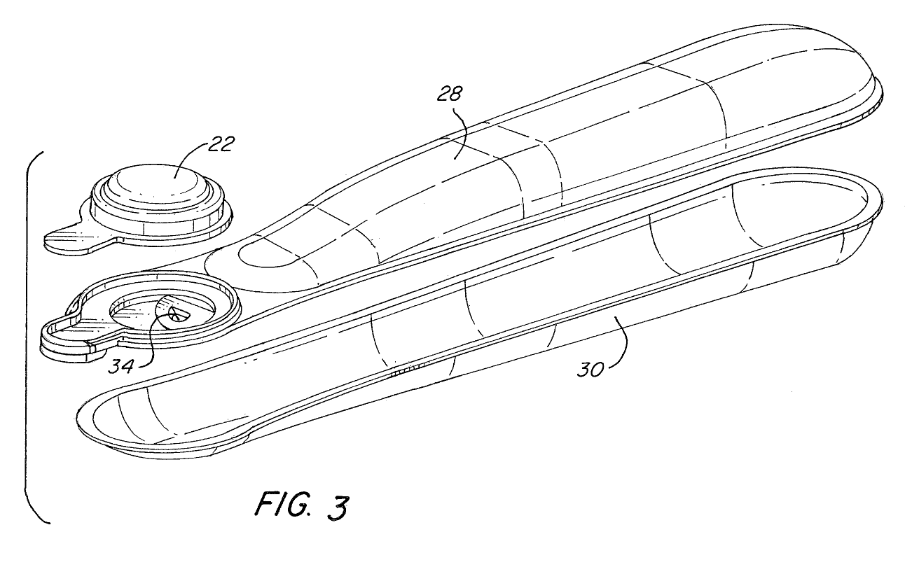

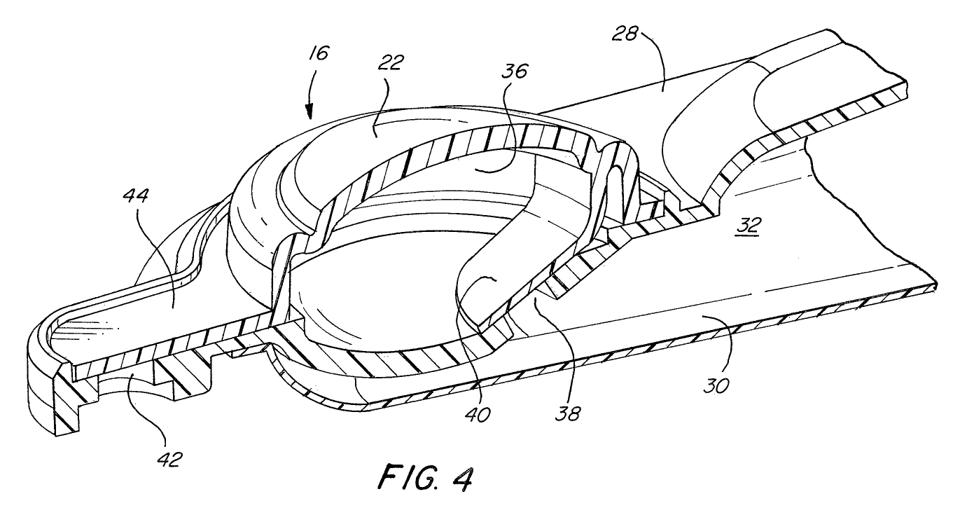

Referring now to FIGS. 3 and 4 in particular, one embodiment of pouch 14, also referred to herein as an integrated mechanism for the dispensing of shaving treatments, is shown in greater detail. Pouch 14 is formed of two portions, an upper portion 28, which may be formed from a rigid or semi-rigid material, such as molded plastic, and a lower portion 30, sealed or otherwise attached to the upper portion 28 to define therebetween a reservoir 32 that contains a volume of shaving treatment therein. The lower portion 30 of the pouch 14 is preferably made of a flexible material, such as plastic or nylon, such that as shaving treatment is evacuated from within the reservoir 32, the lower portion 30 of the pouch 14 will collapse gradually into the more rigid upper portion 28.

A flexible metering button 22 is provided in a corresponding area of the upper portion 28 of the pouch 14 in the vicinity of an opening 34 therethrough. The flexible metering button 22 and the corresponding portion of the upper portion 28 of the pouch 14 thus define a metering chamber 36, with the opening 34 being located between the metering chamber 36 and the reservoir 32. The pumping mechanism 16 further includes an intake one-way valve 38, such as a check valve, to pull shaving treatment from the reservoir 32 of the pouch 14 into the metering chamber 36. Any type of valve can be used to suit the given application, but it is preferable that the intake one-way valve 38 be formed as a flap valve employing a flap of material 40 integrated with the flexible metering button 22. Thus, shaving treatment can only flow in one way from the reservoir 32 into the metering chamber 36. The button 22 may be transparent or translucent to provide an indicator to the user when the metered dosage of shaving treatment is ready for delivery.

An output one-way valve 42, which may also be a one-way check valve, is provided in fluid communication with the metering chamber 36 of the pumping mechanism 16. Thus, the shaving treatment residing in the metering chamber 36 can only exit through the output one-way valve 42. The output one-way valve 42 is also in communication with the output conduit 18 to direct the exit of shaving treatment as described above. Again, any type of valve can be used to suit the given application, but it is preferable that the output one-way valve 42 be formed as a flap valve employing a flap of material 44 integrated with the flexible metering button 22.

Still referring to FIGS. 3 and 4, the operation of the pumping mechanism 16 is further explained. The metering button 22 of the pumping mechanism 16 is depressed to initiate a vacuum operation. More specifically, when the button 22 is released, shaving treatment is pulled from the reservoir 32 of the pouch 14 through the intake one-way valve 38 into the metering chamber 36 which is configured to be of a certain known volume. The act of releasing the button 22 fills the metering chamber 36 to substantial capacity. Thus, a metered amount of shaving treatment is contained within the metering chamber 36 in preparation for delivery. The size of the metering chamber 36 can be selected according to the type of shaving treatment to be dispensed and the application therefor and the desired dosage volume.

A further depression of the button 22 urges the measured volume of shaving treatment within the metering chamber 36 to exit out through the output one-way valve 42 of the pumping mechanism 16. This known amount of shaving treatment is then routed to the shaving head 20 for use or through the fluid conduit 18, as seen in FIG. 1. When the button 22 is again released, additional shaving treatment is pulled from the reservoir 32 of the pouch 14 through the intake one-way valve 38 into the metering chamber 36 and is ready for delivery.

The razor 10 can be designed so that the pouch 14, with integrated pumping mechanism 16, can be easily popped out and replaced with a different shaving treatment depending upon the desires of the user.

It is also conceived as part of this invention, that the pouch 14 can be integrated within the body of a disposable razor assembly, such that the pouch 14 is not designed to be replaced by the user, but the razor 10 thrown away at the end of its useful life. The amount of shaving treatment could be calculated to coincide with the useful life of the razor, and a razor that is empty of the shaving treatment could signal the consumer to dispose of the product.

It is envisioned by the present invention that the disposable razor with a particular shaving treatment could be a convenient way to market new shaving treatments and conveniently to get the consumer to try them, or could simply be a very convenient method for the consumer to travel with a ready to go shaving system. Such a disposable product might also be ideal to be provided in hotel rooms to the traveler.

In view of the foregoing, a new and unique razor, that can serve as the application method for various shaving treatments is provided. This new razor facilitates the convenient integrated delivery of shaving treatments in a metered and dosed manner while providing an attractive appearance that is maintained throughout the use of the product.

The present invention thus provides a method where the shaving treatments may be dispensed reliably and simply from a pouch integrated within the body of the shaving device. The invention provides the integration of a metered dosing pouch containing these shaving products within the shaving device itself. In this manner, the user can reliably and easily apply these products while shaving, and without requiring an additional bottle or container. The present invention has several attributes that can be critical to achieving this result. The use of a vacuum pumping mechanism assures that the shaving treatment can consistently be dosed until the pouch is nearly empty. It does not rely on gravity, so that the shaving treatment dosing is not affected by the relative vertical or horizontal positioning of the razor in use. The pouch can be shaped in such a way to fit within the handle itself, and relies upon the fact that a comfortable handle shape has otherwise wasted internal volume. The dosing method described in the present invention does not involve squeezing the pouch overall, and thus for the most part allows the razor handle shapes to still offer the same design look and feel parameters. Also, the shape of the razor is maintained during the entire use of thereof so that it can be used as desired, and is not affected by the decreasing volume of the contents of the pouch. It is also envisioned, that it is possible to utilize a split pouch so as to dispense or mix while dispensing two or more separate ingredients of the shaving treatment.

Although the invention has been described with reference to a particular arrangement of parts, features and the like, these are not intended to exhaust all possible arrangements or features, and indeed many other modifications and variations will be ascertainable to those of skill in the art.

What is claimed is:

1. A shaving apparatus with integrated dispensing of a shaving treatment comprising:
a main body;
a shaving head attached to said main body; and
an integrated mechanism for the dispensing of the shaving treatment disposed within said main body, said integrated mechanism for the dispensing of the shaving treatment comprising:
a pouch defining a reservoir containing the shaving treatment, at least a portion of said pouch being flexible such that the reservoir decreases in size as the shaving treatment is withdrawn therefrom;
a flexible button accessible by a user of said shaving apparatus, said flexible button at least partially defining a metering chamber in fluid communication with the reservoir;
an output one-way valve in fluid communication with the metering chamber and permitting unidirectional flow of the shaving treatment from the metering chamber when said flexible button is pressed by the user; and
an intake one-way valve disposed between the metering chamber and the reservoir and permitting unidirectional flow of shaving treatment from the reservoir into the metering chamber thereby filling the metering chamber when said flexible button is released by the user.

2. The shaving apparatus of claim 1 wherein said output one-way valve comprises a check valve.

3. The shaving apparatus of claim 2 wherein said output one-way valve comprises a flap valve.

4. The shaving apparatus of claim 3 wherein a flap of the flap valve is integrally formed as part of said flexible button.

5. The shaving apparatus of claim 1 wherein said intake one-way valve comprises a check valve.

6. The shaving apparatus of claim 5 wherein said intake one-way valve comprises a flap valve.

7. The shaving apparatus of claim 6 wherein a flap of the flap valve is integrally formed as part of said flexible button.

8. The shaving apparatus of claim 1 wherein said pouch comprises:
a rigid or semi-rigid portion; and
a flexible portion.

9. The shaving apparatus of claim 8 wherein the metering chamber is at least partially defined by said flexible button and at least partially defined by said pouch.

10. The shaving apparatus of claim 1 further comprising a conduit fluidly connecting said output one-way valve and said shaving head.

11. The shaving apparatus of claim 1 wherein said main body has a hole passing therethrough and wherein said flexible button is accessible through the hole.

12. The shaving apparatus of claim 1 wherein said flexible button is transparent or translucent.

13. The shaving apparatus of claim 1 wherein said integrated mechanism for the dispensing of the shaving treatment is replaceable and said shaving head and said main body are reuseable.

14. A shaving apparatus with integrated dispensing of a shaving treatment comprising:
a main body having a hole passing therethrough;
a shaving head attached to said main body; and
an integrated mechanism for the dispensing of the shaving treatment disposed within said main body, said integrated mechanism for the dispensing of the shaving treatment comprising:
a pouch defining a reservoir containing the shaving treatment, said pouch comprising a rigid or semi-rigid portion and a flexible portion such that the reservoir decreases in size as the shaving treatment is withdrawn therefrom;
a flexible button accessible by a user of said shaving apparatus through the hole passing through said main body, said flexible button and the rigid or semi-rigid portion of said pouch at least partially defining a metering chamber in fluid communication with the reservoir;
an output one-way valve in fluid communication with the metering chamber and permitting unidirectional flow of the shaving treatment from the metering chamber when said flexible button is pressed by the user;
an intake one-way valve disposed between the metering chamber and the reservoir and permitting unidirectional flow of shaving treatment from the reservoir into the metering chamber thereby filling the metering chamber when said flexible button is released by the user; and
wherein at least one of said output one-way valve and said intake one-way valve comprises a flap valve that comprises a flap integrally formed as part of said flexible button.

15. The shaving apparatus of claim 14 wherein both of said output one-way valve and said intake one-way valve comprise flap valves, each of which comprises a flap integrally formed as part of said flexible button.

16. The shaving apparatus of claim 14 further comprising a conduit fluidly connecting said output one-way valve and said shaving head.

17. The shaving apparatus of claim 14 wherein said flexible button is transparent or translucent.

18. The shaving apparatus of claim 14 wherein said integrated mechanism for the dispensing of the shaving treatment is replaceable and said shaving head and said main body are reuseable.
